(19) United States
(12) Patent Application Publication
(10) Pub. No.: US 2025/0355909 A1
(43) Pub. Date: Nov. 20, 2025

(54) CONFIGURABLE NARRATIVE SYSTEM

(71) Applicant: SNORBLE, INCORPORATED, Staten Island, NY (US)

(72) Inventors: Michael-Andreas KUTTNER, Staten Island, NY (US); Mike RIZKALLA, Staten Island, NY (US); Howard H. THAW, Staten Island, NY (US); Daniel Luke SMITS, Staten Island, NY (US); Steven L. HECKER, Staten Island, NY (US)

(73) Assignee: SNORBLE, INCORPORATED, Staten Island, NY (US)

(21) Appl. No.: 19/285,245

(22) Filed: Jul. 30, 2025

Related U.S. Application Data
(63) Continuation of application No. PCT/US2024/013959, filed on Feb. 1, 2024.
(60) Provisional application No. 63/442,621, filed on Feb. 1, 2023.

(51) Int. Cl. G06F 16/3332; G06F 16/38; G06F 40/205

(52) U.S. Cl. CPC G06F 16/3334; G06F 16/38; G06F 40/205

(57) ABSTRACT

The present disclosure relates to a novel and advantageous configurable narrative system and method. In general, the system and method may comprise a storytelling technique, processor for developing a story using the storytelling technique, and a device for telling the story. The present innovations generally address apparatuses, methods, and systems for using keywords and tagging for adding supplemental material to a narrative. More specifically, the system and method comprise an artificially intelligent storytelling system that may be integrated into an electronic device. The electronic device may have any suitable configurations. The electronic device may be equipped with a processor for running the configurable narrative system and display electronics, including audio, visual, or tactile display electronics, for telling the story generated by the processor.

This application is a continuation of International Patent Application No. PCT/US24/13959, filed on Feb. 1, 2024, which claims the benefit of and priority under 35 U.S.C. § 119(e) to U.S. Provisional Patent Application No. 63/442,621, filed on Feb. 1, 2023. The entire disclosures of the foregoing applications are incorporated herein by reference in their entirety.

### FIELD OF THE DISCLOSURE

The present disclosure relates to a novel and advantageous configurable narrative system and method. In general, the system and method may comprise a storytelling technique, processor for developing a story using the storytelling technique, and a device for telling the story. More specifically, the system and method comprise an artificially intelligent storytelling system that may be integrated into an electronic device. The electronic device may have any suitable configurations. The electronic device may be equipped with a processor for running the configurable narrative system and display electronics, including audio, visual, or tactile display electronics, for telling the story generated by the processor.

The present innovations generally address apparatuses, methods, and systems for using keywords and tagging for adding supplemental material to a narrative. As such, the present innovations include (at least) the following distinct area, including: a data processing tool (with a suggested Class/Subclass of 706/16, 17 and 18).

In order to develop a reader's understanding of the innovations, descriptions have been compiled into a single disclosure to illustrate and clarify how aspects of these innovations operate independently, interoperate as between individual innovations, or cooperate collectively. The application goes on to further describe the interrelations and synergies as between the various innovations; all of which is to further comply with 35 U.S.C. § 112.

### BACKGROUND OF THE DISCLOSURE

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Many systems have been developed in the art for telling stories to a user, such as audiobooks and the like. The presently disclosed embodiments provide improvements to these and other kinds of systems, as set forth below.

### BRIEF SUMMARY OF THE DISCLOSURE

This application for letters patent discloses and describes various novel innovations and inventive aspects of content development technology (hereinafter “disclosure”) and contains material that is subject to copyright, mask work, or other intellectual property protection. The respective owners of such intellectual property have no objection to the facsimile reproduction of the disclosure by anyone as it appears in published Patent Office file/records, but otherwise reserve all rights.

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one or more embodiments, relates to a method of operating a system to construct a customized narrative to be conveyed to a recipient. The method may comprise receiving input material from a content creator and receiving tag input from the content creator. The input material may include content of a narrative to be conveyed to a recipient. The tag input may identify at least one location within text of the input material to instruct a device conveying the narrative to the recipient to evaluate whether to introduce supplemental material into the narrative as it is being read.

In various embodiments, the tag input is mapped to an entry in a database, the database containing a plurality of blocks of supplemental material that can be selected by the device conveying the narrative to the recipient. The tag input may include at least one keyword or a plurality of keywords. The tag input may include reference point input concerning where to insert the supplemental material; the reference point may be located at the end of a paragraph of the narrative.

In some embodiments, the narrative may be conveyed in an audiovisual format. The supplemental material may include audio and visual information. The supplemental material may include haptic information. In some embodiments, the manner of presentation constitutes the message itself.

The present disclosure, in one or more embodiments, additionally relates to a method of operating a device including a processor to present a customized narrative. The method may comprise receiving input from a recipient, retrieving input material including a narrative wherein the input material includes at least one tag, parsing the narrative to identify the tab, determining whether to customize the narrative, and conveying the customized narrative to the recipient. Receiving input from a recipient for the device is such that it facilitates presenting to the recipient a customized narrative via processor. Retrieving input material may comprise retrieving input material from a database including the narrative via processor, wherein the input material of the narrative includes at least one tag to instruct the processor to evaluate whether to add input material to the narrative at the location of the tag to customize the narrative. Parsing the narrative may comprise parsing the narrative via the processor to identify the tag via the processor. Determining whether to customize the narrative may be done via the processor and conveying the customized narrative to the recipient may be done via the processor.

In some embodiments, determining whether to customize the narrative via the processor includes selecting a block of supplemental material from a database, and conveying the customized narrative to the recipient via processor includes modifying the narrative to incorporate the supplemental material. The processor may select a particular block of supplemental material to incorporate into the narrative based on information contained within the tag that identifies the particular block of supplemental material.

In various embodiments, the tag may identify a discrete block of supplemental material in the database to incorporate into the narrative. The tag may identify a location in the narrative at which to incorporate supplemental material into the narrative. The tag may identify a plurality of discrete blocks of supplemental material in the database to incorporate into the narrative. The tag may be a keyword, and determining whether to customize the narrative via the processor may include selecting a block of supplemental material from the database based on the keyword. The database may include a first field with the keyword, and a second field associated with the first field, wherein the second field includes the supplemental material to be incorporated into the narrative.

In some embodiments, the method may further comprise selecting at least one of the plurality of discrete blocks of supplemental material via the processor to incorporate into the narrative. Determining whether to customize the narrative via the processor may include implementing an algorithm to determine whether to select a block of supplemental material from a database depending on at least one factor. The at least one factor may include a number of tags in the narrative, wherein the processor assigns a weighting factor to each tag and utilizes the weighting factor to determine which tags are used to select supplemental content from the database.

In further embodiments, the processor may scan the narrative to identify each appearance of a tag and assemble a first composite narrative from the narrative and a plurality of blocks of supplemental material. The method may comprise reciting the first composite narrative to the recipient. The method may further comprise scanning the narrative a second time to create a second composite narrative different from the first composite narrative by incorporating different blocks for supplemental material than the first composite narrative. Each tag may include a keyword, and the processor may scan the entire narrative to find all of words that correlate to reference keywords in the database. The processor may record in which paragraph each word is contained.

The processor may sort through multiple instances of each keyword within the narrative and select a single instance of each keyword to associate with a block of supplemental material from the database. In some embodiments, the process may randomly select identified keywords and select the number of instances that supplemental material is incorporated into the narrative. The processor may randomly select identified keywords and select the number of instances that supplemental material is incorporated into the narrative based at least in part on not repeating the placement of supplemental material from an earlier instance in which a narrative was assembled and conveyed to the recipient. In some embodiments, the processor may sort through multiple instances of each keyword within the narrative and selects a single instance of each keyword to associate with a block of supplemental material from the database using a natural language processing (NLP) methodology.

In a further embodiment, a method of operating a system to construct a customized narrative to be conveyed to a recipient is provided. The method comprises, receiving input material, receiving tag input, scanning the material to locate keywords, selecting keywords for addition of supplemental material, and adding the supplemental material to the narrative. Receiving input material may comprise receiving input material from a content creator, wherein the input material comprises text for the content of a narrative and includes keywords. Receiving tag input may comprise receiving tag input from the content creator identifying at least one location within the text of the material to instruct a device conveying the narrative to the recipient to evaluate whether to introduce supplemental material into the narrative as it is being read. Selecting keywords for addition of supplemental material may comprise identifying keywords at tag locations, reducing instances of keywords having multiple occurrences, and randomly selecting from remaining keywords. Requesting supplemental material may comprise requesting supplemental material associated with each selected keyword from a database and receiving the supplemental material may be from the database. Adding the supplemental material may be at a location proximate the selected keyword.

It is to be understood that the foregoing general description and the following detailed description are exemplary and are intended to provide further explanation of the disclosed embodiments. The accompanying drawings, which are incorporated in and constitute part of this specification, are included to illustrate and provide a further understanding of the disclosed methods and systems. Together with the description, the drawings serve to explain principles of the disclosure.

While multiple embodiments are disclosed, still other embodiments of the present disclosure will become apparent to those skilled in the art from the following detailed description, which shows and describes illustrative embodiments of the disclosure. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the disclosed embodiments will be better understood from the following description taken in conjunction with the accompanying Figures. The accompanying appendices, drawings, figures, images, etc. illustrate various example, non-limiting, inventive aspects, embodiments, and features (“e.g.,” or “example(s)”) in accordance with the present disclosure:

FIG. 1 shows an example of an animated character that can deliver the narrative, in accordance with one embodiment.

FIG. 2 shows an exemplary usage scenario in one embodiment of a system in accordance with the disclosure.

FIG. 3A shows a logic flow diagram illustrating aspects of the system in one embodiment of the present disclosure.

FIG. 3B shows a data flow diagram illustrating aspects of the system in one embodiment of the present disclosure.

FIG. 4 shows a block diagram illustrating an exemplary system coordinator in one embodiment of the disclosure.

### DETAILED DESCRIPTION

Reference will now be made in detail to exemplary present preferred embodiments of the disclosure, examples of which are illustrated in the accompanying drawings. The methods and corresponding steps of the disclosed embodiments will be described in conjunction with the detailed description of the system. Advantages of the present disclosure will be set forth in and become apparent from the description that follows. Additional advantages of the disclosure will be realized and attained by the methods and systems particularly pointed out in the written description and claims hereof, as well as from the appended drawings.

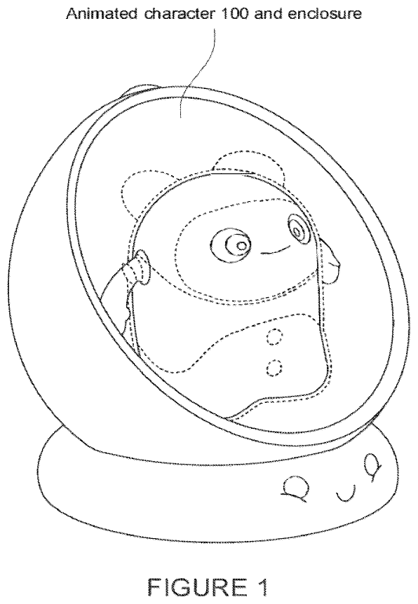

The present disclosure relates to a novel and advantageous configurable narrative system and method. In general, the system and method may comprise a storytelling technique, processor for developing a story using the storytelling technique, and a device for telling the story. The present innovations generally address apparatuses, methods, and systems for using keywords and tagging for adding supplemental material to a narrative. More specifically, the system and method comprise an artificially intelligent storytelling system that may be integrated into an electronic device. The electronic device may have any suitable configurations. The electronic device may be equipped with a processor for running the configurable narrative system and display electronics, including audio, visual, and/or tactile display electronics, for telling the story generated by the processor. In some embodiments, the electronic device may comprise a character. In some embodiments, the electronic device character may be referred to as a Snorble™ character and is an animated character that a child can hug, interact with, and share stories with. FIG. 1 illustrates an animated character 100 that can deliver the narrative, in accordance with one embodiment. As illustrated, if desired, the electronic device may comprise an enclosure.

The system may be referred to as Snorble Markup And Lullaboo Language (SMALL™) and is an artificially intelligent storytelling system for use with an electronic device system platform, such as the Snorble platform. Using the SMALL™ language, a content creator such as a writer can create a story and add semi-random contextual embellishment to their stories without needing coding or interactive storytelling training. The system allows the content creator to focus on crafting a great story. The addition of the SMALL™ language adds the flexibility of keeping the storytelling fresh while keeping the overall story structure intact. The system addresses currently needs in developing stories and, more specifically, developing stories as a story is told to a user. Typically, a story told to a user is a static narrative. In some scenarios, a narrative can change while being told based on selections by a user at a specified point in the narrative. This requires user input and, in order to get a plurality of narratives, a user remembering what selections have been previously input. The current system automatically generates varied narratives based on tag inputs. Using the tag inputs and algorithms using the tag inputs, constantly varying narratives can be developed without user input.

### System Overview

The SMALL™ system comprises three primary elements: a story or narrative, a database, and a processor. Each of these elements is described more fully below.

A narrative is devised by a content creator and includes a basic storyline having one or more locations for the addition of segues or supplemental material. The story thus comprises input material from a content creator and includes content of a narrative to be conveyed to a recipient, such as a child. The input material may comprise text such as a plurality of paragraphs or chapters of text and may include keywords. The content creator may be aware that such words are keywords or may rely on a processor for identifying correlation between input text and keywords in a database. The content creator may further include tag input for identifying at least one location within the narrative to instruct a device convening the narrative to the recipient to evaluate whether to introduce supplemental material into the narrative as it is being developed or compiled. In some embodiments such development may be done dynamically when the story is being told. In other embodiments, the story may be developed at one time and read at another. The tag input may comprise a tag such as <SMALL SillyBreak> that may be appended to the end of a paragraph of text within the narrative. The more tags the content creator or writer includes in the narrative, the more opportunities there are for the program to insert supplemental material (also referred to as a segue).

The configurable narrative system may include a database facilitating insertion of supplemental material. The database may contain keywords that may be present in the narrative. The keywords may each relate to a keyword topic. Supplemental material may be associated with each of these keywords. For example, each keyword may have a supplementary content paragraph associated therewith. The supplementary content paragraph may be a short explanatory paragraph that expounds upon the topic of the keyword. There may be any number of discreet paragraphs available, with each paragraph being a separate entry within the database. Further, each keyword may have a plurality of supplementary content paragraphs associated therewith wherein the plurality of supplementary content paragraphs may all be introduced at a single occurrence of the keyword or may be introduced serially through repeated occurrences of the keyword. In general, the more keywords and the more supplemental content available, the more variety the SMALL enabled story is able to offer upon story telling. A content creator may provide keywords and associated supplemental material or may rely on keywords and associated supplemental material already in the database.

A processor is provided for developing and constructing the customized narrative based on the input material and tag input from the content creator and the keywords and supplemental material in the database. The processor may be referred to as a parsing program and may include a parsing module and a randomizer module. The processor may be configured to scan the input material to detect words correlating to reference keywords in the database. The processor records, indicates, or otherwise tracks at what location, for example at what paragraph, each keyword is contained.

In an embodiment using a single set of supplementary content paragraph(s) per keyword wherein all supplementary content associated with the keyword is presented at a single occurrence of the keyword, the processor sorts through multiple instances of a single keyword and removes all instances except one. Which instance is retained may be random. Sorting may be done using a parsing module. This prevents the system from presenting the same supplementary content multiple times.

In an alternative embodiment, a plurality of supplementary content paragraphs may be provided associated with a keyword wherein each occurrence of the keyword receives a different one of the plurality of keywords, In such embodiment, the processor, and more specifically the parsing module, may sort through multiple instances of a single keyword and reduce the number of instances of the keyword to correlate with the number of supplementary content paragraphs provided associated with that keyword.

A randomizer module may be applied to the keywords in the input material to decide how many times and where to add the supplemental content associated with a keyword. This effectively determines how many times the system will veer off track during the storytelling to talk about a topic. Thus, the system may in one instance make a segue once during one telling of a story, and in another instance make four segues during the telling of the story. Further, these segues may not appear in the same place in the story each time, nor focus on the same topics each time.

Once keyword topics have been determined, the processor, for example using the parser module, queries the database and retrieves one or more supplementary topic paragraphs associated with each topic. The supplementary topic paragraphs are inserted in the narrative at the location of the associated keyword tag. For example, if the tag is at the end of a paragraph, the supplementary topic paragraph associated with that tag may be inserted after the tagged paragraph.

The system and method thus are configured such that each time the story is retold, the system takes one or more segues in telling the story in order to talk a bit more about one of the topics featured in the story.

In one embodiment, the input material includes 20 SillyBreak™ tag reference points, resulting in 7 possible topics which cross reference to 2 possible supplementary paragraphs each. The processor may be set to display, for example, between 2 and 5 of these segues in various places within the story. By compounding these variables, the SMALL system can tell a story a potential 33,600 times with these slight variations before the child hears the exact same retelling of the story for a second time.

A content creator can control the number of tag reference points that appear in each story. The system may be a shared platform wherein the database includes content available to all content creators and grows to include new topics. The system thus can grow to offer millions or even billions of possible variations on the stories written for the Snorble platform, keeping the stories engaging and familiar whilst adding a touch of unpredictability to each retelling that we expect will extend the life of these stories far past the point where they would otherwise be beyond their best before date.

### Device Overview

In one embodiment, the system and method may be used with a base unit enclosure, sometimes referred to as a Lullaboo. The base unit enclosure may be configured to provide an experience via light, sound and haptics that prepares the child and his family for learning the routines that create effective and meaningful life habits. In addition, the base unit may have functionality to connect with other devices, thus providing and allowing for a deeper connectivity via collection of data from said connected peripherals. Further aspects of illustrative systems can be found in International Patent Application No. PCT/US2021/035808, filed Jun. 3, 2021, which is incorporated by reference herein in its entirety for all purposes.

The base unit may include lighting, sound, communication, proximity detection, haptics, indicator lights, and power features.

Lighting may include mood lighting, sequenced lighting, celebratory lighting, and/or spotlight lighting. Mood lighting may be, for example, responsive to time of day, i.e. brighter in the morning, cooler muted colors that dim over time prior to bedtime. Sequenced lighting may correspond to the telling of specific stories, specific routines, etc. Celebratory lighting may mark achievement levels or be set for specific experiences. Spotlight lighting may highlight objects that are placed inside the base unit enclosure, for dramatic effect.

The base unit enclosure may have sound output may be in the form of music, spoken word or sound effect, based on the desired outcome

The base unit enclosure may have communication functionality such as Bluetooth or BILE with other add-on devices, such as projectors and bath toys. In some embodiments the base unit may use the communication to collect information that informs the internal training algorithm for routines.

In some embodiments, the base unit enclosure may be configured to sense if a peripheral device has come within a pre-determined proximity of the base. The base unit enclosure may have functionality to detect the presence of other non-electronic parts that have an RFID/NFC tag, via the appropriate chip and antenna to read the tags.

The base unit enclosure may be configured to provide haptic stimulation. More specifically, to encourage children to engage with the provided activities, as well as to complement other outputs, the base unit enclosure may provide vibrational feedback, which may be programmed to vary in intensity, duration or activation pattern.

The base unit enclosure may have indicator lights such as LEDs or a similar component. The indicator lights may be deployed to indicate overall status such as “connected” or “low battery”, etc.

The base unit may be configured to be powered in any suitable manner, such as by battery or a low-voltage wall transformer.

### Method and Processor

The system and method thus utilize input material from a content creator, tag input from a content creator, keywords and supplemental material associated with the keywords. The system analyzes the semantic content of the content creator's input material, for example by using a combination of statistical, machine-learning, and custom pattern-based methods. Detailed metadata tags may be associated with the tag input. The present disclosure provides a set of user tools for optimizing, extending, and customizing the narrative.

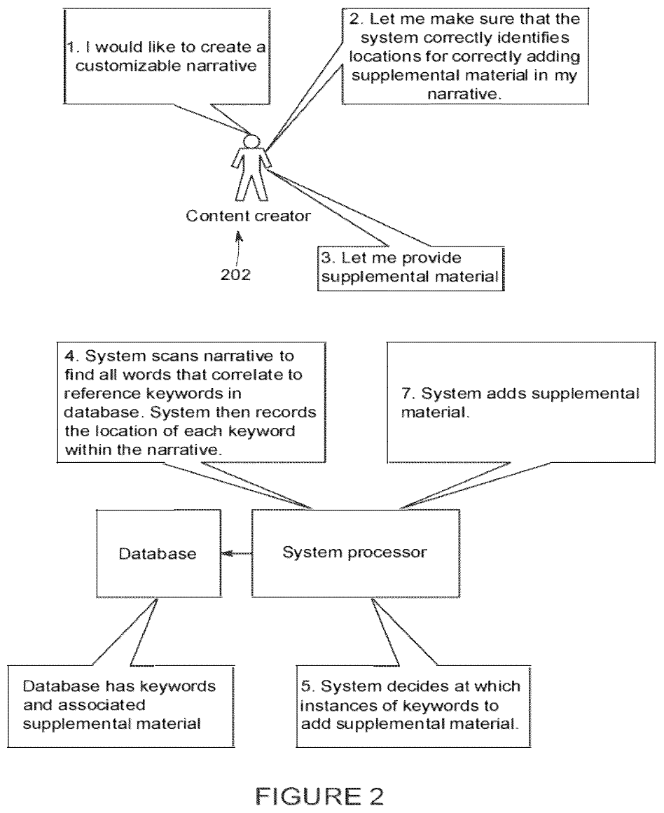

For purposes of illustration, and not limitation, FIG. 2 shows an exemplary usage scenario in one embodiment of the disclosure. In FIG. 2, a content creator 202 may utilize an embodiment of the disclosed system to develop a narrative that may be customized during telling. For example, in use, the system identifies keywords present in a narrative, sorts through multiple instances of each keyword, reduces instances of each keyword, determines which occurrences to add supplemental material to, and adds the supplemental material. Each addition of supplemental material may be referred to as a segue.

In accordance with one illustrative example, a content creator develops a customizable narrative including text and keywords. More specifically, the content creator develops a narrative that may be customized with supplemental content in a randomized fashion. The content creator inputs input material into the system. The content creator further inputs tag input to identify at least one location wherein the narrative may be customized by introducing supplemental material. The content creator may provide the supplemental material or the supplemental material may already be present in a database of the system.

The content creator creates a customizable narrative and inputs input material including keywords for the narrative into the system. The user then identifies locations wherein supplemental material may be introduced to the narrative for customizing the narrative. This may be done by inputting tag input at locations, such as paragraphs, where supplemental material may be introduced. The content creator may input supplemental material into the system or supplemental material may already exist in a database of the system.

The supplemental material may comprise keywords and text associated with each of the keywords. The text may be, for example, explanatory paragraphs that expound upon the topic of the keyword.

The system processor scans the input material to find all words that correlate with reference keywords in the database and records the location of each keyword within the narrative. The system then decides at which instances of keywords to add supplemental material. This may include determining whether a tag is has been placed proximate the location of the keyword, reducing recordation of occurrences of each keyword (for example, reducing to one), and randomly selecting remaining keywords for adding supplemental material. After deciding at which instances of keywords to add supplemental material, the supplemental material is added to the narrative.

In general, after the content creator inputs input material including keywords, tag input, and, optionally, supplemental content, the system can customize the narrative without further input from the content creator.

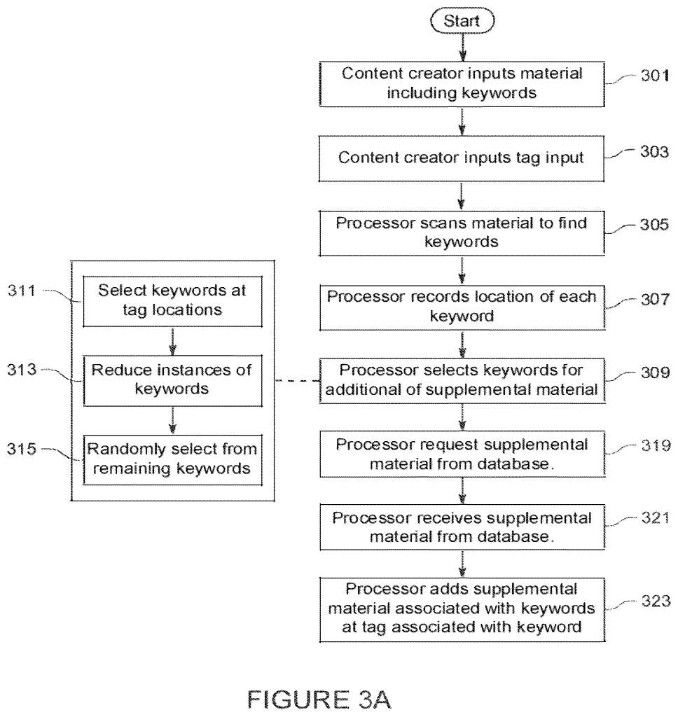

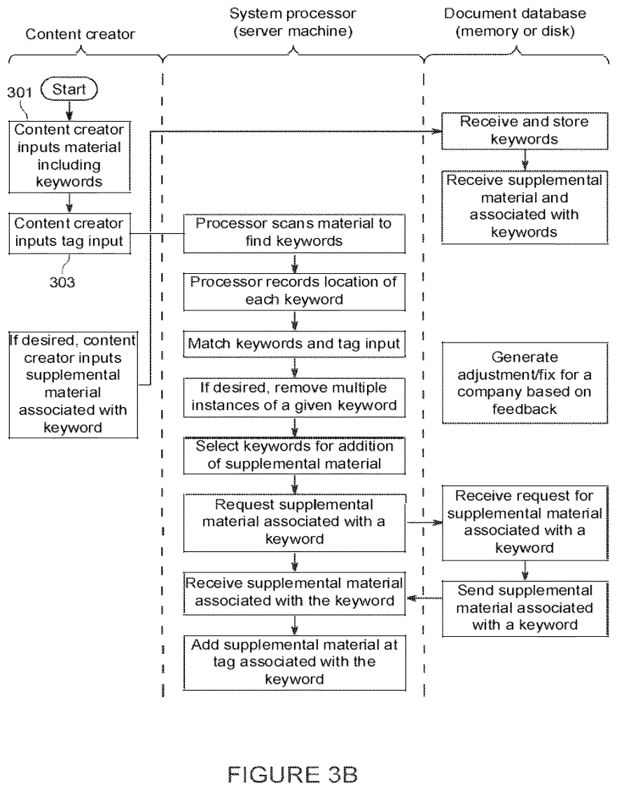

In further accordance with the disclosure, FIG. 3 presents an example of a logic/data flow diagram that illustrates a particular implementation of a method and system in accordance with the present disclosure. While logical elements and steps are presented, it will be appreciated that each actually corresponds to an appropriately programmed circuit module that is configured to execute the logic and move data from one component to another, as instructed by machine readable code that is being executed. The logical steps are separated that take place within or with respect to a machine of a user (client device), a system processor (server) and a database, wherein the devices are delimited from each other by dashed lines. Data flows from one device to another are represented by arrows crossing the dashed lines.

As illustrated in FIGS. 3A and 3B, an illustrative example begins at step 301 with a content creator, (e.g., 202), inputting material including keywords. At step 303, the content creator inputs tag input. The processor scans the material at step 305 to find keywords. The processor records each keyword at step 307 and then selects keywords for addition of supplemental material at step 309. Selecting keywords may comprise selecting keywords that are at tag locations 311, reducing instances of keywords that occur at multiple locations 313, and randomly selecting from the remaining keywords 315. Once keywords have been selected for receiving supplemental material at step 309, the processor requests supplemental material associated with each selected keyword at step 317. The processor receives the supplemental material at step 321 and adds the supplemental material associated with the selected keyword at the location of the tag associated with the keyword at step 323. FIG. 3B illustrates the flow of data from a content creator to a server and a database of the illustrative method.

The present disclosure, in one or more embodiments, relates to a method of operating a system to construct a customized narrative to be conveyed to a recipient. The method may comprise receiving input material from a content creator and receiving tag input from the content creator. The input material may include content of a narrative to be conveyed to a recipient. The tag input may identify at least one location within text of the input material to instruct a device conveying the narrative to the recipient to evaluate whether to introduce supplemental material into the narrative as it is being read.

In various embodiments, the tag input is mapped to an entry in a database, the database containing a plurality of blocks of supplemental material that can be selected by the device conveying the narrative to the recipient. The tag input may include at least one keyword or a plurality of keywords. The tag input may include reference point input concerning where to insert the supplemental material; the reference point may be located at the end of a paragraph of the narrative.

In some embodiments, the narrative may be conveyed in an audiovisual format. The supplemental material may include audio and visual information. The supplemental material may include haptic information. In some embodiments, the manner of presentation constitutes the message itself

The present disclosure, in one or more embodiments, additionally relates to a method of operating a device including a processor to present a customized narrative. The method may comprise receiving input from a recipient, retrieving input material including a narrative wherein the input material includes at least one tag, parsing the narrative to identify the tab, determining whether to customize the narrative, and conveying the customized narrative to the recipient. Receiving input from a recipient for the device is such that it facilitates presenting to the recipient a customized narrative via processor. Retrieving input material may comprise retrieving input material from a database including the narrative via processor, wherein the input material of the narrative includes at least one tag to instruct the processor to evaluate whether to add input material to the narrative at the location of the tag to customize the narrative. Parsing the narrative may comprise parsing the narrative via the processor to identify the tag via the processor. Determining whether to customize the narrative may be done via the processor and conveying the customized narrative to the recipient may be done via the processor.

In some embodiments, determining whether to customize the narrative via the processor includes selecting a block of supplemental material from a database, and conveying the customized narrative to the recipient via processor includes modifying the narrative to incorporate the supplemental material. The processor may select a particular block of supplemental material to incorporate into the narrative based on information contained within the tag that identifies the particular block of supplemental material.

In various embodiments, the tag may identify a discrete block of supplemental material in the database to incorporate into the narrative. The tag may identify a location in the narrative at which to incorporate supplemental material into the narrative. The tag may identify a plurality of discrete blocks of supplemental material in the database to incorporate into the narrative. The tag may be a keyword, and determining whether to customize the narrative via the processor may include selecting a block of supplemental material from the database based on the keyword. The database may include a first field with the keyword, and a second field associated with the first field, wherein the second field includes the supplemental material to be incorporated into the narrative.

In some embodiments, the method may further comprise selecting at least one of the plurality of discrete blocks of supplemental material via the processor to incorporate into the narrative. Determining whether to customize the narrative via the processor may include implementing an algorithm to determine whether to select a block of supplemental material from a database depending on at least one factor. The at least one factor may include a number of tags in the narrative, wherein the processor assigns a weighting factor to each tag and utilizes the weighting factor to determine which tags are used to select supplemental content from the database.

In further embodiments, the processor may scan the narrative to identify each appearance of a tag and assemble a first composite narrative from the narrative and a plurality of blocks of supplemental material. The method may comprise reciting the first composite narrative to the recipient. The method may further comprise scanning the narrative a second time to create a second composite narrative different from the first composite narrative by incorporating different blocks for supplemental material than the first composite narrative. Each tag may include a keyword, and the processor may scan the entire narrative to find all of words that correlate to reference keywords in the database. The processor may record in which paragraph each word is contained.

The processor may sort through multiple instances of each keyword within the narrative and select a single instance of each keyword to associate with a block of supplemental material from the database. In some embodiments, the process may randomly select identified keywords and select the number of instances that supplemental material is incorporated into the narrative. The processor may randomly select identified keywords and select the number of instances that supplemental material is incorporated into the narrative based at least in part on not repeating the placement of supplemental material from an earlier instance in which a narrative was assembled and conveyed to the recipient. In some embodiments, the processor may sort through multiple instances of each keyword within the narrative and selects a single instance of each keyword to associate with a block of supplemental material from the database using a natural language processing (NLP) methodology.

### Detailed Description of the Coordinator

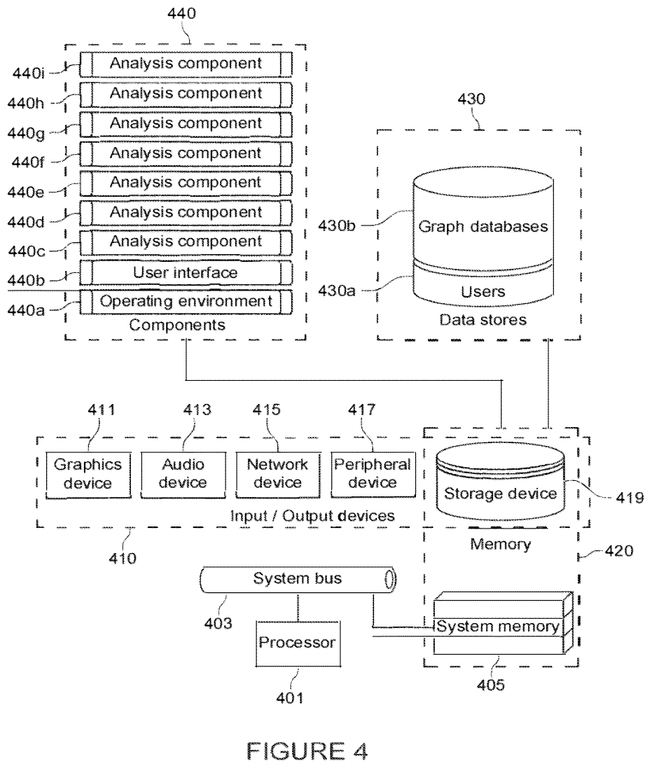

FIG. 4 shows a block diagram illustrating an exemplary coordinator in one embodiment of the disclosed embodiments. The coordinator facilitates the operation of the disclosed embodiments via a computer system (e.g., one or more cloud computing systems, grid computing systems, virtualized computer systems, mainframe computers, servers, clients, nodes, desktops, mobile devices such as smart phones, cellular phones, tablets, personal digital assistants (PDAs), and/or the like, embedded computers, dedicated computers, a system on a chip (SOC)). For example, the coordinator may receive, obtain, aggregate, process, generate, store, retrieve, send, delete, input, output, and/or the like data (including program data and program instructions); may execute program instructions; may communicate with computer systems, with nodes, with users, and/or the like. In various embodiments, the coordinator may comprise a standalone computer system, a distributed computer system, a node in a computer network (i.e., a network of computer systems organized in a topology), a network of coordinators, and/or the like. It is to be understood that the coordinator and/or the various coordinator elements (e.g., processor, system bus, memory, input/output devices) may be organized in any number of ways (i.e., using any number and configuration of computer systems, computer networks, nodes, coordinator elements, and/or the like) to facilitate operation. Furthermore, it is to be understood that the various coordinator computer systems, coordinator computer networks, coordinator nodes, coordinator elements, and/or the like may communicate among each other in any number of ways to facilitate operation. As used in this disclosure, the term “user” refers generally to people and/or computer systems; the term “server” refers generally to a computer system, a program, and/or a combination thereof that handles requests and/or responds to requests from clients via a computer network; the term “client” refers generally to a computer system, a program, a user, and/or a combination thereof that generates requests and/or handles responses from servers via a computer network; outside of the context of a graph database the term “node” refers generally to a server, to a client, and/or to an intermediary computer system, program, and/or a combination thereof that facilitates transmission of and/or handling of requests and/or responses.

The coordinator includes a processor 401 that executes program instructions. The processor may include a parsing module and a randomizer module. In various embodiments, the processor may be a general purpose microprocessor (e.g., a central processing unit (CPU)), a dedicated microprocessor (e.g., a graphics processing unit (GPU), a physics processing unit (PPU), a digital signal processor (DSP), a network processor, and/or the like), an external processor, a plurality of processors (e.g., working in parallel, distributed, and/or the like), a microcontroller (e.g., for an embedded system), and/or the like. The processor may be implemented using integrated circuits (ICs), application-specific integrated circuits (ASICs), field-programmable gate arrays (FPGAs), and/or the like. In various implementations, the processor may comprise one or more cores, may include embedded elements (e.g., a coprocessor such as a math coprocessor, a cryptographic coprocessor, a physics coprocessor, and/or the like, registers, cache memory, software), may be synchronous (e.g., using a clock signal) or asynchronous (e.g., without a central clock), and/or the like. For example, the processor may be an AMD FX processor, an AMD Opteron processor, an AMD Geode LX processor, an Intel Core i7 processor, an Intel Xeon processor, an Intel Atom processor, an ARM Cortex processor, an IBM PowerPC processor, and/or the like.

The processor may be connected to system memory 405 via a system bus 403. The system bus may interconnect these and/or other elements of the coordinator via electrical, electronic, optical, wireless, and/or the like communication links (e.g., the system bus may be integrated into a motherboard that interconnects coordinator elements and provides power from a power supply). In various embodiments, the system bus may comprise one or more control buses, address buses, data buses, memory buses, peripheral buses, and/or the like. In various implementations, the system bus may be a parallel bus, a serial bus, a daisy chain design, a hub design, and/or the like. For example, the system bus may comprise a front-side bus, a back-side bus, Al\1D's HyperTransport, Intel's QuickPath Interconnect, a peripheral component interconnect (PCI) bus, an accelerated graphics port (AGP) bus, a PCI Express bus, a low pin count (LPC) bus, a universal serial bus (USB), and/or the like. The system memory, in various embodiments, may comprise registers, cache memory (e.g., level one, level two, level three), read only memory (ROM) (e.g., BIOS, flash memory), random access memory (RAM) (e.g., static RAM (SRAM), dynamic RAM (DRAM), error-correcting code (ECC) memory), and/or the like. The system memory may be discreet, external, embedded, integrated into a CPU, and/or the like. The processor may access, read from, write to, store in, erase, modify, and/or the like, the system memory in accordance with program instructions executed by the processor. The system memory may facilitate accessing, storing, retrieving, modifying, deleting, and/or the like data by the processor.

In various embodiments, input/output devices 410 may be connected to the processor and/or to the system memory, and/or to one another via the system bus. Exemplary output devices may comprise a character electronic device or an enclosure electronic device. Such devices may produce audio, visual, and/or tactile output based on the narrative developed by the processor.

In some embodiments, the input/output devices may include one or more graphics devices 411. The processor may make use of the one or more graphic devices in accordance with program instructions executed by the processor. In one implementation, a graphics device may be a video card that may obtain (e.g., via a connected video camera), process (e.g., render a frame), output (e.g., via a connected monitor, television, and/or the like), and/or the like graphical (e.g., multimedia, video, image, text) data. A video card may be connected to the system bus via an interface such as PCI, AGP, PCI Express, USB, PC Card, ExpressCard, and/or the like. A video card may use one or more graphics processing units (GPUs), for example, by utilizing AMD's CrossFireX and/or NVIDIA's SLI technologies. A video card may be connected via an interface (e.g., video graphics array (VGA), digital video interface (DVI), Mini-DVI, Micro-DVI, high-definition multimedia interface (HDMI), DisplayPort, Thunderbolt, composite video, S-Video, component video, and/or the like) to one or more displays (e.g., cathode ray tube (CRT), liquid crystal display (LCD), touchscreen, and/or the like) that display graphics. For example, a video card may be an AMD Radeon HD 6990, an ATI Mobility Radeon HD 5870, an AMD FirePro V9800P, an AMD Radeon E6760 MXM V3.0 Module, an NVIDIA GeForce GTX 590, an NVIDIA GeForce GTX 580M, an Intel HD Graphics 3000, and/or the like. In another implementation, a graphics device may be a video capture board that may obtain (e.g., via coaxial cable), process (e.g., overlay with other graphical data), capture, convert (e.g., between different formats, such as MPEG2 to H.264), and/or the like graphical data. A video capture board may be and/or include a TV tuner, may be compatible with a variety of broadcast signals (e.g., NTSC, PAL, ATSC, QAM) may be a part of a video card, and/or the like. For example, a video capture board may be an ATI All-in-Wonder HD, a Hauppauge ImpactVBR 01381, a Hauppauge WinTV-HVR-2250, a Hauppauge Colossus 01414, and/or the like. A graphics device may be discreet, external, embedded, integrated into a CPU, and/or the like. A graphics device may operate in combination with other graphics devices (e.g., in parallel) to provide improved capabilities, data throughput, color depth, and/or the like.

In some embodiments, the input/output devices may include one or more audio devices 413. The processor may make use of the one or more audio devices in accordance with program instructions executed by the processor. In one implementation, an audio device may be a sound card that may obtain (e.g., via a connected microphone), process, output (e.g., via connected speakers), and/or the like audio data. A sound card may be connected to the system bus via an interface such as PCI, PCI Express, USB, PC Card, ExpressCard, and/or the like. A sound card may be connected via an interface (e.g., tip sleeve (TS), tip ring sleeve (TRS), RCA, TOSLINK, optical) to one or more amplifiers, speakers (e.g., mono, stereo, surround sound), subwoofers, digital musical instruments, and/or the like. For example, a sound card may be an Intel AC'97 integrated codec chip, an Intel HD Audio integrated codec chip, a Creative Sound Blaster X-Fi Titanium HD, a Creative Sound Blaster X-Fi Go! Pro, a Creative Sound Blaster Recon 3D, a Turtle Beach Riviera, a Turtle Beach Amigo II, and/or the like. An audio device may be discreet, external, embedded, integrated into a motherboard, and/or the like. An audio device may operate in combination with other audio devices (e.g., in parallel) to provide improved capabilities, data throughput, audio quality, and/or the like.

In some embodiments, the input/output devices may include one or more network devices 415. The processor may make use of the one or more network devices in accordance with program instructions executed by the processor. In one implementation, a network device may be a network card that may obtain (e.g., via a Category 5 Ethernet cable), process, output (e.g., via a wireless antenna), and/or the like network data. A network card may be connected to the system bus via an interface such as PCI, PCI Express, USB, FireWire, PC Card, ExpressCard, and/or the like. A network card may be a wired network card (e.g., 10/100/1000, optical fiber), a wireless network card (e.g., Wi-Fi 802.11a/b/g/n/ac/ad, Bluetooth, Near Field Communication (NFC), TransferJet), a modem (e.g., dialup telephone-based, asymmetric digital subscriber line (ADSL), cable modem, power line modem, wireless modem based on cellular protocols such as high speed packet access (HSPA), evolution-data optimized (EV-DO), global system for mobile communications (GSM), worldwide interoperability for microwave access (WiMax), long term evolution (LTE), and/or the like, satellite modem, FM radio modem, radio-frequency identification (RFID) modem, infrared (IR) modem), and/or the like. For example, a network card may be an Intel EXPI9301CT, an Intel EXPI9402PT, a LINKSYS USB300M, a BUFFALO WLI-UC-G450, a Rosewill RNX-MiniNl, a TRENDnet TEW-623PI, a Rosewill RNX-Nl80UBE, an ASUS USB-BT21 1, a MOTOROLA SB6120, a U.S. Robotics USR5686G, a Zoom 5697-00-00F, a TRENDnet TPL-401E2K, a D-Link DHP-W306AV, a StarTech ET91000SC, a Broadcom BCM20791, a Broadcom InConcert BCM4330, a Broadcom BCM4360, an LG VL600, a Qualcomm MDM9600, a Toshiba TC35420 TransferJet device, and/or the like. A network device may be discreet, external, embedded, integrated into a motherboard, and/or the like. A network device may operate in combination with other network devices (e.g., in parallel) to provide improved data throughput, redundancy, and/or the like. For example, protocols such as link aggregation control protocol (LACP) based on IEEE 802.3AD-2000 or IEEE 802.1AX-2008 standards may be used. A network device may be used to connect to a local area network (LAN), a wide area network (WAN), a metropolitan area network (MAN), a personal area network, the Internet, an intranet, a Bluetooth network, an NFC network, a Wi-Fi network, a cellular network, and/or the like.

In some embodiments, the input/output devices may include one or more peripheral devices 417. The processor may make use of the one or more peripheral devices in accordance with program instructions executed by the processor. In various implementations, a peripheral device may be a digital camera, a video camera, a webcam, an electronically moveable pan tilt zoom (PTZ) camera, a monitor, a touchscreen display, active shutter 3D glasses, head-tracking 3D glasses, a remote control, an audio line-in, an audio line-out, a microphone, headphones, speakers, a subwoofer, a router, a hub, a switch, a firewall, an antenna, a keyboard, a mouse, a trackpad, a trackball, a digitizing tablet, a stylus, a joystick, a gamepad, a game controller, a force-feedback device, a laser, sensors (e.g., proximity sensor, rangefinder, ambient temperature sensor, ambient light sensor, humidity sensor, an accelerometer, a gyroscope, a motion sensor, an olfaction sensor, a biosensor, a chemical sensor, a magnetometer, a radar, a sonar, a location sensor such as global positioning system (GPS), Galileo, GLONASS, and/or the like), a printer, a fax, a scanner, a copier, a card reader, and/or the like. A peripheral device may be connected to the system bus via an interface such as PCI, PCI Express, USB, FireWire, VGA, DVI, Mini-DYi, Micro-DYi, HDMI, DisplayPort, Thunderbolt, composite video, S-Video, component video, PC Card, ExpressCard, serial port, parallel port, PS/2, TS, TRS, RCA, TOSLINK, network connection (e.g., wired such as Ethernet, optical fiber, and/or the like, wireless such as Wi-Fi, Bluetooth, NFC, cellular, and/or the like), a connector of another input/output device, and/or the like. A peripheral device may be discreet, external, embedded, integrated (e.g., into a processor, into a motherboard), and/or the like. A peripheral device may operate in combination with other peripheral devices (e.g., in parallel) to provide the coordinator with a variety of input, output and processing capabilities.

In some embodiments, the input/output devices may include one or more storage devices 419. The processor may access, read from, write to, store in, erase, modify, and/or the like a storage device in accordance with program instructions executed by the processor. A storage device may facilitate accessing, storing, retrieving, modifying, deleting, and/or the like data (e.g., graph database data as described elsewhere herein) by the processor. In one implementation, the processor may access data from the storage device directly via the system bus. In another implementation, the processor may access data from the storage device by instructing the storage device to transfer the data to the system memory and accessing the data from the system memory. In various embodiments, a storage device may be a hard disk drive (HDD), a solid-state drive (SSD), a floppy drive using diskettes, an optical disk drive (e.g., compact disk (CD-ROM) drive, CD-Recordable (CD-R) drive, CD-Rewriteable (CD-RW) drive, digital versatile disc (DVD-ROM) drive, DVD-R drive, DVD-RW drive, Blu-ray disk (BD) drive) using an optical medium, a magnetic tape drive using a magnetic tape, a memory card (e.g., a USB flash drive, a compact flash (CF) card, a secure digital extended capacity (SDXC) card), a network attached storage (NAS), a direct-attached storage (DAS), a storage area network (SAN), other processor-readable physical mediums, and/or the like. A storage device may be connected to the system bus via an interface such as PCI, PCI Express, USB, FireWire, PC Card, ExpressCard, integrated drive electronics (IDE), serial advanced technology attachment (SAIA), external SAIA (eSATA), small computer system interface (SCSI), serial attached SCSI (SAS), fibre channel (FC), network connection (e.g., wired such as Ethernet, optical fiber, and/or the like; wireless such as Wi-Fi, Bluetooth, NFC, cellular, and/or the like), and/or the like. A storage device may be discreet, external, embedded, integrated (e.g., into a motherboard, into another storage device), and/or the like. A storage device may operate in combination with other storage devices to provide improved capacity, data throughput, data redundancy, and/or the like. For example, protocols such as redundant array of independent disks (RAID) (e.g., RAID O (striping), RAID I (mirroring), RAID 5 (striping with distributed parity), hybrid RAID), just a bunch of drives (JBOD), and/or the like may be used. In another example, virtual and/or physical drives may be pooled to create a storage pool. In yet another example, an SSD cache may be used with a HDD to improve speed.

Together and/or separately the system memory 405 and the one or more storage devices 419 may be referred to as memory 420 (i.e., physical memory).

Memory 420 contains processor-operable (e.g., accessible) data stores 430. Data stores 430 comprise data that may be used via the coordinator. The data may include keywords and supplemental material associated with each keyword. Such data may be organized using one or more data formats such as one or more of a database (e.g., a relational database with database tables, an object-oriented database, a graph database, a hierarchical database), a flat file (e.g., organized into a tabular format), a binary file (e.g., a GIF file, an MPEG-4 file), a structured file (e.g., an HTl\1L file, an XML file), a text file, and/or the like. Furthermore, data may be organized using one or more data structures such as an array, a queue, a stack, a set, a linked list, a map, a tree, a hash, a record, an object, a directed graph, and/or the like. In various embodiments, data stores may be organized in any number of ways (i.e., using any number and configuration of data formats, data structures, coordinator elements, and/or the like) to facilitate operation.

System memory 420 contains processor-operable (e.g., executable) components 440. Components 440 comprise program components (including program instructions and any associated data stores) that are executed via the coordinator (i.e., via the processor) to transform inputs into outputs. It is to be understood that the various components and their subcomponents, capabilities, applications, and/or the like may be organized in any number of ways (i.e., using any number and configuration of components, subcomponents, capabilities, applications, coordinator elements, and/or the like) to facilitate operation. Furthermore, it is to be understood that the various components and their subcomponents, capabilities, applications, and/or the like may communicate among each other in any number of ways to facilitate operation. For example, the various components and their subcomponents, capabilities, applications, and/or the like may be combined, integrated, consolidated, split up, distributed, and/or the like in any number of ways to facilitate operation. In another example, a single or multiple instances of the various components and their subcomponents, capabilities, applications, and/or the like may be instantiated on each of a single coordinator node, across multiple coordinator nodes, and/or the like.

In various embodiments, program components may be developed using one or more programming languages, techniques, tools, and/or the like such as an assembly language, Ada, BASIC, C, C++, C#, COBOL, Fortran, Java, LabVIEW, Lisp, Mathematica, MATLAB, OCaml, PL/I, Smalltalk, Visual Basic for Applications (VBA), HTML, XML, CSS, JavaScript, JavaScript Object Notation (JSON), PHP, Perl, Ruby, Python, Asynchronous JavaScript and XML (AJAX), WebSocket Protocol, Simple Object Access Protocol (SOAP), SSL, ColdFusion, Microsoft .NET, Apache modules, Adobe Flash, Adobe AIR, Microsoft Silverlight, Windows PowerShell, batch files, Tel, graphical user interface (GUI) toolkits, SQL, database adapters, web application programming interfaces (APis), application server extensions, integrated development environments (IDEs), libraries (e.g., object libraries, class libraries, remote libraries), remote procedure calls (RPCs), Common Object Request Broker Architecture (COREA), and/or the like.

In some embodiments, components 440 may include an operating environment component 440a. The operating environment component may facilitate operation of the system via various subcomponents. In some implementations, the operating environment component may include an operating system subcomponent. The operating system subcomponent may provide an abstraction layer that facilitates the use of, communication among, common services for, interaction with, security of, and/or the like of various coordinator elements, components, data stores, and/or the like.

In some embodiments, the operating system subcomponent may facilitate execution of program instructions by the processor by providing process management capabilities. For example, the operating system subcomponent may facilitate the use of multiple processors, the execution of multiple processes, multitasking, and/or the like.

In some embodiments, the operating system subcomponent may facilitate the use of memory by the system. For example, the operating system subcomponent may allocate and/or free memory, facilitate memory addressing, provide memory segmentation and/or protection, provide virtual memory capability, facilitate caching, and/or the like. In another example, the operating system subcomponent may include a file system (e.g., File Allocation Table (FAT), New Technology File System (NTFS), Hierarchical File System Plus (HFS+), Universal Disk Format (UDF), Linear Tape File System (LTFS)) to facilitate storage, retrieval, deletion, aggregation, processing, generation, and/or the like of data.

In some embodiments, the operating system subcomponent may facilitate operation of and/or processing of data for and/or from input/output devices. For example, the operating system subcomponent may include one or more device drivers, interrupt handlers, file systems, and/or the like that allow interaction with input/output devices.

In some embodiments, the operating system subcomponent may facilitate operation of the coordinator as a node in a computer network by providing support for one or more communications protocols. For example, the operating system subcomponent may include support for the internet protocol suite (i.e., Transmission Control Protocol/Internet Protocol (TCP/IP)) of network protocols such as TCP, IP, User Datagram Protocol (UDP), Mobile IP, and/or the like. In another example, the operating system subcomponent may include support for security protocols (e.g., Wired Equivalent Privacy (WEP), Wi-Fi Protected Access (WPA), WPA2) for wireless computer networks. In yet another example, the operating system subcomponent may include support for virtual private networks (VPNs).

In some embodiments, the operating system subcomponent may facilitate security of the coordinator. For example, the operating system subcomponent may provide services such as authentication, authorization, audit, network intrusion-detection capabilities, firewall capabilities, antivirus capabilities, and/or the like.

In some embodiments, the operating system subcomponent may facilitate user interaction with the system by providing user interface elements that may be used by the system to generate a user interface. In one implementation, such user interface elements may include widgets (e.g., windows, dialog boxes, scrollbars, menu bars, tabs, ribbons, menus, buttons, text boxes, checkboxes, combo boxes, drop-down lists, list boxes, radio buttons, sliders, spinners, grids, labels, progress indicators, icons, tooltips, and/or the like) that may be used to obtain input from and/or provide output to the user. For example, such widgets may be used via a widget toolkit such as Microsoft Foundation Classes (MFC), Apple Cocoa Touch, Java Swing, GTK+, Qt, Yahoo! User Interface Library (YUi), and/or the like. In another implementation, such user interface elements may include sounds (e.g., event notification sounds stored in MP3 file format), animations, vibrations, and/or the like that may be used to inform the user regarding occurrence of various events. For example, the operating system subcomponent may include a user interface such as Windows Aero, Mac OS X Aqua, GNOME Shell, KDE Plasma Workspaces (e.g., Plasma Desktop, Plasma Netbook, Plasma Contour, Plasma Mobile), and/or the like.

In various embodiments the operating system subcomponent may comprise a single-user operating system, a multi-user operating system, a single-tasking operating system, a multitasking operating system, a single-processor operating system, a multiprocessor operating system, a distributed operating system, an embedded operating system, a real-time operating system, and/or the like. For example, the operating system subcomponent may comprise an operating system such as UNIX, LINUX, IBM i, Sun Solaris, Microsoft Windows Server, Microsoft DOS, Microsoft Windows 7, Microsoft Windows 8, Windows 10, Windows 11, Apple Mac OS X, Apple iOS, Android, Symbian, Windows Phone 7, Windows Phone 8, Blackberry QNX, and/or the like.

In some implementations, the operating environment component may include a database subcomponent. The database subcomponent may facilitate capabilities such as storage, analysis, retrieval, access, modification, deletion, aggregation, generation, and/or the like of data (e.g., the use of data stores 1130). The database subcomponent may make use of database languages (e.g., Structured Query Language (SQL), XQuery), stored procedures, triggers, APis, and/or the like to provide these capabilities. In various embodiments the database subcomponent may comprise a cloud database, a data warehouse, a distributed database, an embedded database, a parallel database, a real-time database, and/or the like. For example, the database subcomponent may comprise a database such as Microsoft SQL Server, Microsoft Access, MySQL, IBM DB2, Oracle Database, Apache Cassandra database, and/or the like.

In some implementations, the operating environment component may include an information handling subcomponent. The information handling subcomponent may provide the system with capabilities to serve, deliver, upload, obtain, present, download, and/or the like a variety of information. The information handling subcomponent may use protocols such as Hypertext Transfer Protocol (HTTP), Hypertext Transfer Protocol Secure (HTTPS), File Transfer Protocol (FTP), Telnet, Secure Shell (SSH), Transport Layer Security (TLS), Secure Sockets Layer (SSL), peer-to-peer (P2P) protocols (e.g., BitTorrent), and/or the like to handle communication of information such as web pages, files, multimedia content (e.g., streaming media), applications, and/or the like.

In some embodiments, the information handling subcomponent may facilitate the serving of information to users, system components, nodes in a computer network, web browsers, and/or the like. For example, the information handling subcomponent may comprise a web server such as Apache HTTP Server, Microsoft Internet Information Services (US), Oracle WebLogic Server, Adobe Flash Media Server, Adobe Content Server, and/or the like. Furthermore, a web server may include extensions, plug-ins, add-ons, servlets, and/or the like. For example, these may include Apache modules, IIS extensions, Java servlets, and/or the like. In some implementations, the information handling subcomponent may communicate with the database subcomponent via standards such as Open Database Connectivity (ODBC), Java Database Connectivity (JDBC), ActiveX Data Objects for .NET (ADO.NET), and/or the like. For example, the information handling subcomponent may use such standards to store, analyze, retrieve, access, modify, delete, aggregate, generate, and/or the like data (e.g., data from data stores 430) via the database subcomponent.

In some embodiments, the information handling subcomponent may facilitate presentation of information obtained from users, system components, nodes in a computer network, web servers, and/or the like. For example, the information handling subcomponent may comprise a web browser such as Microsoft Internet Explorer, Mozilla Firefox, Apple Safari, Google Chrome, Opera Mobile, Amazon Silk, Nintendo 3DS Internet Browser, and/or the like. Furthermore, a web browser may include extensions, plug-ins, add-ons, applets, and/or the like. For example, these may include Adobe Flash Player, Adobe Acrobat plug-in, Microsoft Silverlight plug-in, Microsoft Office plug-in, Java plug-in, and/or the like.

In some implementations, the operating environment component may include a messaging subcomponent. The messaging subcomponent may facilitate system message communications capabilities. The messaging subcomponent may use protocols such as Simple Mail Transfer Protocol (SMTP), Internet Message Access Protocol (IMAP), Post Office Protocol (POP), Extensible Messaging and Presence Protocol (XMPP), Real-time Transport Protocol (RTP), Internet Relay Chat (IRC), Skype protocol, AOL's Open System for Communication in Realtime (OSCAR), Messaging Application Programming Interface (MAPI), Facebook API, a custom protocol, and/or the like to facilitate system message communications. The messaging subcomponent may facilitate message communications such as email, instant messaging, Voice over IP (VoIP), video conferencing, Short Message Service (SMS), web chat, in-app messaging (e.g., alerts, notifications), and/or the like. For example, the messaging subcomponent may comprise Microsoft Exchange Server, Microsoft Outlook, Sendmail, IBM Lotus Domino, Gmail, AOL Instant Messenger (AIM), Yahoo Messenger, ICQ, Trillian, Skype, Google Talk, Apple FaceTime, Apple iChat, Facebook Chat, and/or the like.

In some implementations, the operating environment component may include a security subcomponent that facilitates system security. In some embodiments, the security subcomponent may restrict access to the system, to one or more services provided by the system, to data associated with the system (e.g., stored in data stores 430), to communication messages associated with the system, and/or the like to authorized users. Access may be granted via a login screen, via an API that obtains authentication information, via an authentication token, and/or the like. For example, the user may obtain access by providing a username and/or a password (e.g., a string of characters, a picture password), a personal identification number (PIN), an identification card, a magnetic stripe card, a smart card, a biometric identifier (e.g., a finger print, a voice print, a retina scan, a face scan), a gesture (e.g., a swipe), a media access control (MAC) address, an IP address, and/or the like. Various security models such as access-control lists (ACLs), capability-based security, hierarchical protection domains, and/or the like may be used to control access. For example, the security subcomponent may facilitate digital rights management (DRM), network intrusion detection, firewall capabilities, and/or the like.

In some embodiments, the security subcomponent may use cryptographic techniques to secure information (e.g., by storing encrypted data), verify message authentication (e.g., via a digital signature), provide integrity checking (e.g., a checksum), and/or the like by facilitating encryption and/or decryption of data. Furthermore, steganographic techniques may be used instead of or in combination with cryptographic techniques. Cryptographic techniques used by the system may include symmetric key cryptography using shared keys (e.g., using one or more block ciphers such as triple Data Encryption Standard (DES), Advanced Encryption Standard (AES); stream ciphers such as Rivest Cipher 4 (RC4), Rabbit), asymmetric key cryptography using a public key/private key pair (e.g., using algorithms such as Rivest-Shamir-Adleman (RSA), Digital Signature Algorithm (DSA)), cryptographic hash functions (e.g., using algorithms such as Message-Digest 5 (MD5), Secure Hash Algorithm 2 (SHA-2)), and/or the like. For example, the security subcomponent may comprise a cryptographic system such as Pretty Good Privacy (PGP).

In some implementations, the operating environment component may include a virtualization subcomponent that facilitates system virtualization capabilities. In some embodiments, the virtualization subcomponent may provide support for platform virtualization (e.g., via a virtual machine). Platform virtualization types may include full virtualization, partial virtualization, paravirtualization, and/or the like. In some implementations, platform virtualization may be hardware-assisted (e.g., via support from the processor using technologies such as AMD-V, Intel VT-x, and/or the like). In some embodiments, the virtualization subcomponent may provide support for various other virtualized environments such as via operating-system level virtualization, desktop virtualization, workspace virtualization, mobile virtualization, application virtualization, database virtualization, and/or the like. In some embodiments, the virtualization subcomponent may provide support for various virtualized resources such as via memory virtualization, storage virtualization, data virtualization, network virtualization, and/or the like. For example, the virtualization subcomponent may comprise VMware software suite (e.g., VMware Server, VMware Workstation, VMware Player, VMware ESX, VMware ESXi, VMware ThinApp, VMware Infrastructure), Parallels software suite (e.g., Parallels Server, Parallels Workstation, Parallels Desktop, Parallels Mobile, Parallels Virtuozzo Containers), Oracle software suite (e.g., Oracle VM Server for SPARC, Oracle VM Server for x86, Oracle VM VirtualBox, Oracle Solaris 10, Oracle Solaris 11), Informatica Data Services, Wine, and/or the like.

In some embodiments, components 440 may include a user interface component 440b for use by a content creator. The user interface component may facilitate user interaction with the system by providing a user interface. In various implementations, the user interface component may include programmatic instructions to obtain input from and/or provide output to the user via physical controls (e.g., physical buttons, switches, knobs, wheels, dials), textual user interface, audio user interface, GUI, voice recognition, gesture recognition, touch and/or multi-touch user interface, messages, APis, and/or the like. In some implementations, the user interface component may make use of the user interface elements provided by the operating system subcomponent of the operating environment component. For example, the user interface component may make use of the operating system subcomponent's user interface elements via a widget toolkit. In some implementations, the user interface component may make use of information presentation capabilities provided by the information handling subcomponent of the operating environment component. For example, the user interface component may make use of a web browser to provide a user interface via HTML5, Adobe Flash, Microsoft Silverlight, and/or the like.

In order to address various issues and advance the art, the entirety of this application (including the Cover Page, Title, Headings, Field, Background, Summary, Brief Description of the Drawings, Detailed Description, Claims, Abstract, Figures, Appendices or otherwise) shows by way of illustration various embodiments in which the claimed innovations may be practiced. The advantages and features of the application are of a representative sample of embodiments only, and are not exhaustive or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent Thus, it is to be understood that other embodiments may be utilized and functional, logical, operational, organizational, structural or topological modifications may be made without departing from the scope or spirit of the disclosure. As such, all examples or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical or topological structure of any combination of any program components (a component collection), other components or any present feature sets as described in the figures or throughout are not limited to a fixed operating order or arrangement, but rather, any disclosed order is exemplary and all equivalents, regardless of order, are contemplated by the disclosure. Furthermore, it is to be understood that such features are not limited to serial execution, but rather, any number of threads, processes, services, servers, or the like that may execute asynchronously, concurrently, in parallel, simultaneously, synchronously, or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations, including the right to claim such innovations, file additional applications, continuations, continuations in part, divisions, or the like thereof. As such, it should be understood that advantages, embodiments, examples, functional, features, logical, operational, organizational, structural, topological, or other aspects of the disclosure are not to be considered limitations on the disclosure as defined by the claims or limitations on equivalents to the claims.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Descriptions herein of circuitry and method steps and computer programs represent conceptual embodiments of illustrative circuitry and software embodying the principles of the disclosed embodiments. Thus the functions of the various elements shown and described herein may be provided through the use of dedicated hardware as well as hardware capable of executing software in association with appropriate software as set forth herein.

In the disclosure hereof any element expressed as a means for performing a specified function is intended to encompass any way of performing that function including, for example, a) a combination of circuit elements and associated hardware which perform that function orb) software in any form, including, therefore, firmware, microcode or the like as set forth herein, combined with appropriate circuitry for executing that software to perform the function. Applicants thus regard any means which can provide those functionalities as equivalent to those shown herein.

Similarly, it will be appreciated that the system and process flows described herein represent various processes which may be substantially represented in computer-readable media and so executed by a computer or processor, whether or not such computer or processor is explicitly shown. Moreover, the various processes can be understood as representing not only processing and/or other functions but, alternatively, as blocks of program code that carry out such processing or functions.

The methods, systems, computer programs and mobile devices of the present disclosure, as described above and shown in the drawings, among other things, provide for methods for developing a customized narrative, systems and machine readable programs for carrying out the same. It will be apparent to those skilled in the art that various modifications and variations can be made in the devices, methods, software programs and mobile devices of the present disclosure without departing from the spirit or scope of the disclosure. Thus, it is intended that the present disclosure include modifications and variations that are within the scope of the subject disclosure and equivalents.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A method of operating a system to construct a customized narrative to be conveyed to a recipient, comprising:
receiving input material from a content creator including content of a narrative to be conveyed to a recipient;
receiving tag input from the content creator identifying at least one location within the text of the material to instruct a device conveying the narrative to the recipient to evaluate whether to introduce supplemental material into the narrative as it is developed;
wherein the tag input includes at least one keyword.

2. The method of claim 1, wherein the tag input is mapped to an entry in a database, the database containing a plurality of blocks of supplemental material that can be selected by the device conveying the narrative to the recipient.

3. The method of claim 1, wherein the tag input includes reference point input concerning where to insert the supplemental material.

4. The method of claim 3, wherein the reference point is located at the end of a paragraph of the narrative.

5. The method of claim 1, wherein the narrative is conveyed in an audiovisual format and wherein the supplemental material includes audio and visual information.

6. The method of claim 1, wherein the supplemental material includes haptic information.

7. A method of operating a device including a processor to present a customized narrative, comprising:
receiving input from a recipient for the device to present to the recipient a customized narrative via the processor;
retrieving input material from a database including the narrative via processor, wherein the input material of the narrative includes at least one tag to instruct the processor to evaluate whether to add input material to the narrative at the location of the tag to customize the narrative;
parsing the narrative via the processor to identify the tag via the processor; determining whether to customize the narrative via the processor; and conveying the customized narrative to the recipient via the processor.

8. The method of claim 7, wherein determining whether to customize the narrative via processor includes selecting a block of supplemental material from the database, and further wherein conveying the customized narrative to the recipient via the processor includes modifying the narrative to incorporate the block of supplemental material.

9. The method of claim 8, wherein the processor selects a particular block of supplemental material to incorporate into the narrative based on information contained within the tag that identifies the particular block of supplemental material.

10. The method of claim 8, wherein the tag identifies a plurality of discrete blocks of supplemental material in the database to incorporate into the narrative, and further comprising selecting at least one of the plurality of discrete blocks of supplemental material via the processor to incorporate into the narrative.

11. The method of claim 7, wherein determining whether to customize the narrative via the processor includes implementing an algorithm to determine whether to select a block of supplemental material from a database depending on at least one factor, wherein the at least one factor includes a number of tags in the narrative, wherein the processor assigns a weighting factor to each tag and utilizes the weighting factor to determine which tags are used to select supplemental content from the database.

12. The method of claim 11, wherein the tag is a keyword, and further wherein determining whether to customize the narrative via the processor includes selecting a block of supplemental material from the database based on the keyword.

13. The method of claim 12, wherein the database includes a first field with the keyword, and a second field associated with the first field, wherein the second field includes the supplemental material to be incorporated into the narrative.

14. The method of claim 7, wherein the processor scans the narrative to identify each appearance of a tag, and then assembles a first composite narrative from the narrative and a plurality of blocks of supplemental material, and further wherein the method further comprises reciting the first composite narrative to the recipient.

15. The method of 14, further comprising scanning the narrative a second time to create a second composite narrative different from the first composite narrative by incorporating different blocks for supplemental material than the first composite narrative.

16. The method of claim 14, wherein each tag includes a keyword, and further wherein the processor scans the entire narrative to find all of the words that correlate to reference keywords in the database, and wherein the processor records which paragraph each keyword is contained within.

17. The method of claim 16, wherein the processor sorts through multiple instances of each keyword within the narrative and selects a single instance of each keyword to associate with a block of supplemental material from the database.

18. The method of claim 17, wherein the processor randomly selects identified keywords and selects the number of instances that supplemental material is incorporated into the narrative.

19. The method of claim 17, wherein the processor sorts through multiple instances of each keyword within the narrative and selects a single instance of each keyword to associate with a block of supplemental material from the database (1) using a natural language processing (NLP) methodology or (2) based at least in part on not repeating the placement of supplemental material from an earlier instance in which a narrative was assembled and conveyed to the recipient.

20. A method of operating a system to construct a customized narrative to be conveyed to a recipient, comprising:
receiving input material from a content creator, wherein the input material comprises text for the content of a narrative and includes keywords;
receiving tag input from the content creator identifying at least one location within the text of the material to instruct a device conveying the narrative to the recipient to evaluate whether to introduce supplemental material into the narrative as it is being read;
scanning the material to locate the keywords;
selecting keywords for addition of supplemental material;
requesting supplemental material associated with each selected keyword from a database;
receiving the supplemental material associated with each selected keyword from the database; and
adding the supplemental material at a location proximate the selected keyword;
wherein selecting keywords for addition of supplemental material comprises identifying keywords at tag locations, reducing instances of keywords having multiple occurrences, and randomly selecting from remaining keywords.
